(19) United States
(12) Patent Application Publication
(10) Pub. No.: US 2025/0242402 A1
(43) Pub. Date: Jul. 31, 2025

(54) METHOD FOR PRODUCING A CONNECTING WEB WITH A REDUCED THICKNESS WHILE CUTTING A WORKPIECE PART FROM A PLATE-SHAPED WORKPIECE, AND CORRESPONDING CONTROL PROGRAM PRODUCT

(71) Applicant: TRUMPF WERKZEUGMASCHINEN SE + CO. KG, Ditzingen (DE)

(72) Inventors: Patrick Mach, Korb (DE); Takeshi Abiko, Ditzingen (DE)

(21) Appl. No.: 19/184,411

(22) Filed: Apr. 21, 2025

Related U.S. Application Data
(63) Continuation of application No. PCT/EP2023/079160, filed on Oct. 19, 2023.

(30) Foreign Application Priority Data
Oct. 20, 2022 (DE) 10 2022 127 687.2

(51) Int. Cl. B21D 28/10; B21D 19/00; B23K 26/00

(52) U.S. Cl. CPC B21D 28/10; B21D 19/005; B23K 26/0093

(57) ABSTRACT

A method for producing a connecting web with reduced thickness while cutting a workpiece part from a plate-shaped workpiece keeps the cut part attached to a remaining grid of the workpiece by the web. The web is produced prior to cutting the workpiece part, and the web is squeezed on a web section adjoining the part to be cut, in thickness direction of the workpiece to set back the squeezed web relative to a plate side of the workpiece in direction of the workpiece center. A workpiece edge formed by the setback of the squeezed web forms an edge of the part to be cut, and a separating gap, corresponding to the contour of the workpiece part and interrupted along the edge formed by the setback of the squeezed web, is cut into the workpiece, keeping the workpiece part attached to the remaining grid by the squeezed web.

### CROSS-REFERENCE TO RELATED APPLICATION

This application is a continuation, under 35 U.S.C. § 120, of copending International Patent Application PCT/EP2023/079160, filed Oct. 19, 2023, which designated the United States; this application also claims the priority, under 35 U.S.C. § 119, of German Patent Application DE 10 2022 127 687.2, filed Oct. 20, 2022; the prior applications are herewith incorporated by reference in their entirety.

### FIELD AND BACKGROUND OF THE INVENTION

The invention relates to a method for producing at least one connecting web with a reduced thickness while cutting a workpiece part from a plate-shaped workpiece, as well as to a control program product, including computer code adapted to perform the method according to the invention when the program runs on a control system of a suitable machine tool.

Such a method is known, for example, from European Patent Application EP 3 088 096 A1, corresponding to U.S. Pat. No. 10,058,907 B2.

During punching or punch-laser machining, connecting webs, so-called “microjoints,” are left in place to fix cut workpiece parts, through which the workpiece parts continue to be connected to the residual remaining grid. The microjoints make it very difficult to remove the workpiece parts from the remaining grid by hand, especially with sheet thicknesses greater than 2 mm. In addition, it is not possible to round or chamfer the edge of the workpiece part at the location of a microjoint, since the microjoint extends over the entire workpiece thickness.

In the method known from European Patent Application EP 3 088 096 A1, corresponding to U.S. Pat. No. 10,058,907 B2, a workpiece part is cut from a plate-shaped workpiece while leaving a connecting web. The connecting web is then pressure-formed using a forming tool in order to reduce the thickness of the connecting web.

It is also known from International Publication WO 2022/037797 A1 that, during laser cutting of a workpiece part from a plate-shaped workpiece, one or multiple connecting webs are left between the workpiece part and the remaining grid and the cutting edge of the workpiece part still connected to the remaining grid is machined, in particular rounded, using the laser beam.

### SUMMARY OF THE INVENTION

In contrast, it is accordingly an object of the invention to provide a method for producing a connecting web with a reduced thickness while cutting a workpiece part from a plate-shaped workpiece, and a corresponding control program product, which overcome the hereinafore-mentioned disadvantages of the heretofore-known methods and program products of this general type, and in which, despite a connecting web existing, subsequent edge machining along the entire contour of the workpiece part should be possible.

With the foregoing and other objects in view there is provided, in accordance with the invention, a method for producing at least one connecting web with a reduced thickness while cutting a workpiece part from a plate-shaped workpiece, wherein the cut workpiece part remains attached to a remaining grid of the workpiece by the connecting web, the method comprising:
producing the at least one connecting web prior to cutting the workpiece part;
squeezing the connecting web at least on a web section which adjoins the workpiece part which is still to be cut, in the thickness direction of the workpiece, in order to set back the squeezed connecting web relative to at least one of the two plate sides of the workpiece in the direction of the workpiece center, wherein a workpiece edge formed by the set-back of the squeezed connecting web forms an edge of the workpiece part which is still to be cut; and
cutting a separating gap, which corresponds to the contour of the workpiece part and which is interrupted along the edge formed by the set-back of the squeezed connecting web, into the workpiece, whereby the workpiece part remains attached to the remaining grid of the workpiece by the squeezed connecting web.

According to the invention, the connecting web (“microjoint”) is squeezed on one or both sides and thereby reduced in thickness, so that the metallic connection point of the connecting web is displaced towards the center of the sheet. Due to the reduced thickness of the squeezed connecting web, the cut workpiece part can be easily removed from the remaining grid, even when the workpiece thickness is greater than 2 mm. The set-back of the squeezed connecting web also creates a straight edge of the future workpiece part in the workpiece, which together with the subsequent cutting edge of the workpiece part forms a continuous edge of the workpiece part. This continuous edge can then be rounded or chamfered in a subsequent machining step using an edge machining tool.

Particular preference is given to a cutting edge of the cut workpiece part and the edge of the workpiece part formed by the return set-back of the squeezed connecting web, which together form a continuous edge of the workpiece part, being machined, in particular rounded or chamfered, by using an edge machining tool guided along the (entire) contour of the workpiece part.

The connecting web can be squeezed to a lesser thickness at a web end on the side of the workpiece part than on the web end on the side of the remaining grid, in order to advantageously form a predetermined breaking point to the workpiece part on the web end on the side of the workpiece part. The squeezed connecting web preferably has a, for example, wedge-shaped, cross-section tapering in the direction of the web end on the side of the workpiece part in a longitudinal plane spanned by its longitudinal direction and its thickness direction.

The connecting web is particularly preferably squeezed at least on the web section which adjoins the workpiece part which is still to be cut, on both sides in the thickness direction, in order to set back the squeezed connecting web relative to the two plate sides of the workpiece in the direction of the workpiece center, wherein the edges of the workpiece formed by the bilateral set-back of the squeezed connecting web each form an edge of the workpiece part which is still to be cut. The squeezed connecting web is only located in the center of the sheet thickness; this makes it possible to apply a continuous edge rounding or chamfer on both sides over the entire contour of the workpiece part that is still connected to the remaining grid, despite the squeezed connecting web.

Subsequently, the cutting edges of the cut workpiece part and the edges of the workpiece part formed by the bilateral set-back of the squeezed connecting web, which together form a continuous edge of the workpiece part, are simultaneously machined, in particular rounded or chamfered, by using an edge machining tool guided along the (entire) contour of the workpiece part.

Preferably, the connecting web in the workpiece is produced by two spaced-apart cutouts, which form the connecting web between them. The separating gap can open into the cutouts, in particular into a cutout tip of the cutouts, on both sides of the squeezed connecting web. In this case, the squeezed connecting web is only connected to the workpiece part at the front side. If the separating gap on both sides of the squeezed connecting web does not open into the cutouts, the squeezed connecting web is also still connected to the remaining grid on both sides. The ideal shape for the cutouts is a triangle, because then the remaining grid can exert a supporting force on the squeezed connecting web during subsequent edge machining of the workpiece part with an edge machining tool, and the edge rounding tool is not pushed aside. cutouts with a shape other than a triangle are also conceivable. The cutouts can be punched out of the workpiece or cut out with a machining beam, e.g., laser beam.

Instead of first creating and then squeezing the connecting web by using two cutouts in two separate steps, this can alternatively also occur in one single step, in which the connecting web is simultaneously punched by using a suitable punching tool and squeezed on one or both sides in the thickness direction of the workpiece at least on the web section adjacent to the workpiece part which is still to be cut. The workpiece is therefore not completely punched through at the point of the connecting web. The squeezed connecting web is preferably located in the lower third of the workpiece part thickness.

Preferably, the separating gap is cut with a machining beam, e.g., a laser beam, or a punching tool.

With the objects of the invention in view, there is concomitantly provided a control program product comprising program code adapted to perform all the steps of the method according to the invention when the program runs on a control system of a machine tool suitable for performing all the steps of the method according to the invention.

Other features which are considered as characteristic for the invention are set forth in the appended claims.

Although the invention is illustrated and described herein as embodied in a method for producing a connecting web with a reduced thickness while cutting a workpiece part from a plate-shaped workpiece, and a corresponding control program product, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

Similarly, the features mentioned above and those still to be further presented can be used in each case individually or together in any desired combinations. The embodiments shown and described should not be understood as an exhaustive list, but rather are of an exemplary character for describing the invention.

### BRIEF DESCRIPTION OF THE FIGURES

FIG. 1 is a diagrammatic, perspective view of a machine tool for sheet machining with a cutting station and a forming station;

FIG. 2 is a fragmentary, perspective top view of a sheet with two cutouts forming a connecting web between them;

FIGS. 3a-3c include a perspective top view (FIG. 3a) as well as a perspective sectional view (FIG. 3b) and a longitudinal section of the squeezed connecting web (FIG. 3c) showing the sheet with a squeezed connecting web;

FIGS. 4a-4c include a perspective top view (FIG. 4a), a squeezed connecting web in a top view (FIG. 4b) and a perspective sectional view (FIG. 4c) showing the sheet with a workpiece part cut out except for the squeezed connecting web;

FIGS. 5a-5c include a perspective top view (FIG. 5a) as well as a longitudinal section (FIG. 5b) and a perspective sectional view (FIG. 5c) showing an edge rounding of the workpiece part cut out except for the squeezed connecting web by using an edge rounding tool; and

FIG. 6 is a perspective top view showing the finished workpiece part.

### DETAILED DESCRIPTION OF THE INVENTION

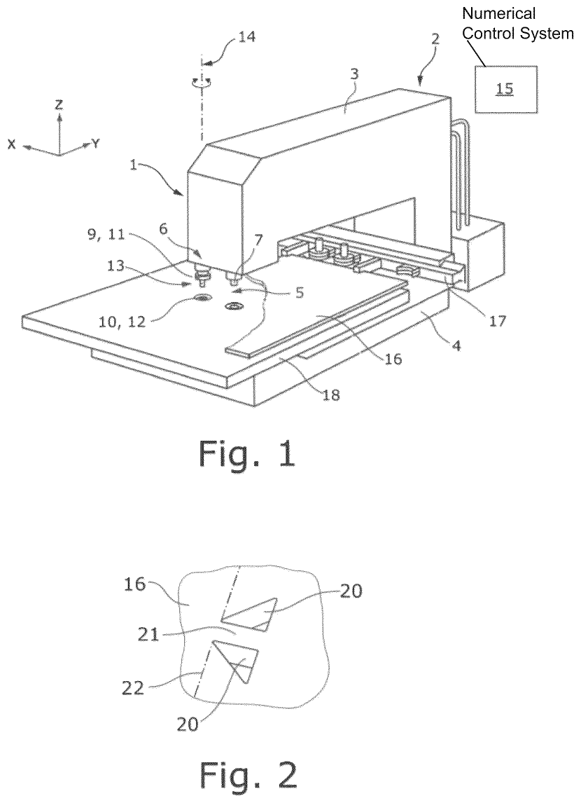

Referring now to the figures of the drawing in detail and first, particularly to FIG. 1 thereof, there is seen a machine tool 1 configured as a combined punching and laser cutting machine. A machine frame 2 of the machine tool 1 has a C-shape and has an upper frame leg 3 and a lower frame leg 4. At the free ends of the upper frame leg 3 and the lower frame leg 4, a laser cutting station 5 and a forming station 6 are provided.

The laser cutting station 5 includes a laser cutting head 7 on the upper frame leg 3 and a laser beam holder 8 on the lower frame leg 4. The forming station 6 has an upper tool holder 9 on the upper frame leg 3 and a lower tool holder 10 on the lower frame leg 4. An upper tool configured as a punch 11 can be inserted into the upper tool holder 9, and a lower tool configured as a die 12 can be inserted into the lower tool holder 10. The punch 11 and the die 12 are tool parts of a forming tool or punching tool 13.

Through the use of a conventional lift drive, the punch 11 can be raised and lowered relative to the die 12 longitudinally along a stroke axis 14. The upper tool holder 9 and the lower tool holder 10, together with the punch 11 and the die 12, are rotatably adjustable about the stroke axis 14 (double arrow in FIG. 1). All functions of the machine tool 1 are controlled by a programmable numerical control system 15.

Plate-shaped workpieces 16, formed of sheet metal in the example shown, are machined at the laser cutting station 5 and the forming station 6. For machining purposes, the sheet 16 is moved by using a conventional coordinate guide 17 with a two-axis horizontal movement over a workpiece support 18 of the machine tool 1 and thereby relative to the laser cutting head 7 and the laser beam holder 8 and also relative to the forming tool 13. In FIG. 1, the sheet 16 is shown broken off, whereby the laser beam holder 8 and the lower tool holder 10 with the forming die 12 of the forming tool 13 can be seen. Due to a movement of the sheet 16 produced by using the coordinate guide 17, a laser beam directed from the laser cutting head 7 onto the sheet 16 cuts sheet parts (e.g., finished parts) free while leaving connecting webs (“microjoints”). As a result of the remaining connection created via the connecting webs, the remaining grid and the sheet parts are only incompletely separated from each other. Instead of the laser cutting beam, a different type of cutting tool, in particular a punching tool inserted at the forming station 6, could also be used for the incomplete separation of the remaining grid and the sheet parts.

FIGS. 2 to 6 show the method steps of the machining method according to the invention carried out on the machine tool 1 in order to cut a workpiece part 19 (FIG. 6), subsequently referred to as the finished part, from the sheet 16 (e.g., 2 mm mild steel) and, while the finished part 19 is still connected to the remaining grid of the sheet 16 via a connecting web with a reduced thickness, to machine the edges of the finished part 19 along the entire finished part contour.

In a first method step, a corresponding punching tool 13 is used to punch two spaced-apart recesses or cutouts 20 in the sheet 16, which form a connecting web (“microjoint”) 21 between them (FIG. 2). This allows material to flow to the side into the two cutouts 20 during the subsequent forming of the connecting web 21. Preferably, the cutouts 20 open into a separating gap 22 that is yet to be created. Alternatively, the cutouts 20 can also be introduced with the laser beam of the laser cutting head 7. The cutouts 20 are configured, for example, as triangles, in particular with rounded corners, which form the connecting web 21 between mutually facing triangular sides and each open with a triangular tip into the separating gap 22 yet to be created.

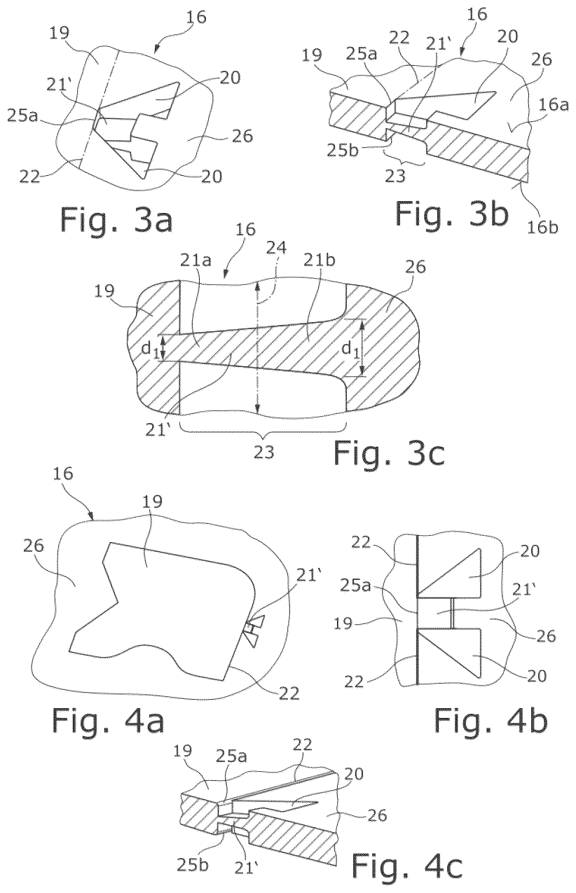

In a second method step, the connecting web 21 is squeezed on a web section 23 adjacent to the future finished part 19 still to be cut (or alternatively over its entire web length) in the thickness direction 24 of the sheet 16 by using a corresponding forming tool (embossing tool) 13 in order to move the connecting web 21 back towards the center of the workpiece with respect to one of the two plate sides 16a, 16b of the sheet 16 or, as shown, with respect to both plate sides 16a, 16b (FIGS. 3a-3c). The squeezed connecting web or web section is designated by 21′ and forms, for example, a so-called nanojoint. The excess material from the squeezing process flows into the previously made cutouts 20. The squeezed connecting web 21′ is now located in the center of the sheet thickness and is preferably a maximum of ⅓ of the sheet thickness. The straight upper and lower edges 25a, 25b formed by the set-back of the squeezed connecting web 21′ on the future finished part 19 correspond to the contour of the future finished part 19.

As shown in FIG. 3c, the connecting web 21 is squeezed more strongly at its web end 21a on the finished part side, which is connected to the future finished part 19, than at its web end 21b on the side of the remaining grid, which is connected to the future remaining grid 26, whereby the squeezed connecting web 21′ has, in this case, a wedge-shaped, cross-section tapering in the direction of the web end 21a on the side of the finished part in a longitudinal plane spanned by its longitudinal direction and its thickness direction 24. The web thickness d₁ of the web end 21a on the finished part side is smaller than the web thickness d₂ of the web end 21b on the remaining part side, i.e., d₁<d₂, in order to form a predetermined breaking point to the finished part 19 at the web end 21a on the side of the workpiece part.

Instead of first creating and then squeezing the connecting web 21 in two separate steps, this can alternatively be done in a single step by simultaneously both punching out and squeezing the connecting web 21 using a suitable punching tool. The sheet 16 is therefore not completely punched through at the point of the connecting web 21. The squeezed connecting web 21′ is preferably located in the lower third of the sheet thickness.

In a third method step, a separating gap 22 corresponding to the contour of the finished part 19, which is interrupted along the squeezed connecting web 21′ or the upper and lower edges 25a, 25b, is cut into the sheet 16 (FIGS. 4a-4c). The separating gap 22 opens into the cutouts 20 on both sides of the squeezed connecting web 21′, whereby the finished part 19 is only held on the remaining grid 26 by the squeezed connecting web 21′. The separating gap 22 is cut out with the laser beam or alternatively created with a punching tool 13. Preferably, the laser beam should be used to cut the contour, since the cutting gap, with its size of a few tenths of a millimeter, then has the ideal shape for a subsequently used edge machining tool.

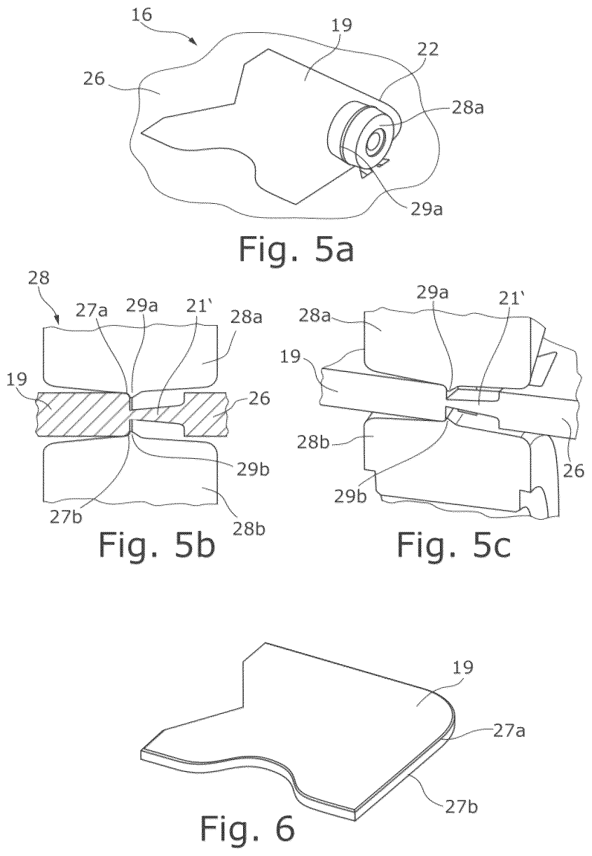

In an optional, fourth method step, the edges of the finished part 19 are processed, e.g., rounded, along the entire contour of the finished part 19, i.e., both along the upper and lower cutting edges 27a, 27b and along the upper and bottom or lower edges 25a, 25b, by using an edge machining tool 28, which is inserted in place of the forming tool or punching tool 13 (FIGS. 5a-5c). The edge machining tool 28 is shown here as an example as a roller pinching tool with an upper tool roller 28a in the upper tool and a lower tool roll 28b in the lower tool. This means that edge rounding can be carried out simultaneously on the upper and bottom sides of the sheet. The tool rollers 28a, 28b have an annular rounding projection 29a, 29b with a rounding radius (e.g., 0.5 mm or smaller) on the circumference side and engage in the separating gap 22. The tool rollers 28a, 28b are displaced or subjected to force in the separating gap 22 towards the finished part 19 in order to round the upper edges and lower edges 25a, 25b and the cutting edges 27a, 27b of the finished part 19. The punch of the upper tool presses on the upper tool roller 28a to generate the necessary contact pressure. The punch is spring-mounted and can therefore compensate for fluctuations in sheet thickness. Instead of the two-sided component rounding shown, only the upper edges 25a, 27a or only the lower edges 25b, 27b can alternatively be processed, e.g., rounded, using a corresponding edge machining tool (one-sided component rounding). For example, a ball deburring tool can also be used as the edge machining tool 28 in order to round the edges 25a, 25b and 27a, 27b by roller deburring.

The finished part 19 is now completed and can be ejected from the machine tool 1 (FIG. 6). For this purpose, the squeezed connecting web 21′ can be punched away in the machine tool 1 or cut open by a laser beam before the then free finished part 19 is ejected via a parts chute. Alternatively, the finished part 19 can also remain attached to the remaining grid 26 and be removed from the remaining grid 26 at a later time, by breaking open the squeezed connecting web 21′, either manually or with mechanical assistance.

1. A method for producing at least one connecting web with a reduced thickness while cutting a workpiece part from a plate-shaped workpiece with the cut workpiece part remaining attached to a remaining grid of the workpiece by the connecting web, the method comprising:
producing the at least one connecting web in the workpiece prior to cutting the workpiece part;
squeezing the connecting web at least on a web section adjoining the workpiece part still to be cut, in a thickness direction of the workpiece, to set back the squeezed connecting web relative to at least one of two plate sides of the workpiece in a direction of a workpiece center, causing a workpiece edge formed by the set-back of the squeezed connecting web to form an edge of the workpiece part still to be cut; and
cutting a separating gap corresponding to a contour of the workpiece part and being interrupted along the edge formed by the set-back of the squeezed connecting web, into the workpiece, causing the workpiece part to remain attached to the remaining grid of the workpiece by the squeezed connecting web.

2. The method according to claim 1, which further comprises machining a cutting edge of the cut workpiece part and the edge of the workpiece part formed by the set-back of the squeezed connecting web by using an edge machining tool guided along the contour of the workpiece part.

3. The method according to claim 1, which further comprises squeezing the connecting web to a lesser thickness at a web end on a side of the workpiece part than at a web end on a side of the remaining grid.

4. The method according to claim 1, which further comprises providing the squeezed connecting web with a cross-section tapering in a direction of a web end on a side of the workpiece part in a longitudinal plane spanned by a longitudinal direction of the workpiece part and the thickness direction of the workpiece part.

5. The method according to claim 1, which further comprises squeezing the connecting web on both sides in the thickness direction at least on the web section adjacent to the workpiece part still to be cut, to bilaterally set back the squeezed connecting web relative to the two plate sides of the workpiece in the direction of the workpiece center, the edges of the workpiece formed by the bilateral set-back of the squeezed connecting web each forming an edge of the workpiece part still to be cut.

6. The method according to claim 5, which further comprises simultaneously machining the cutting edges of the cut workpiece part and the edges of the workpiece part formed by the bilateral set-back of the squeezed connecting web by using an edge machining tool guided along the contour of the workpiece part.

7. The method according to claim 1, which further comprises producing the connecting web in the workpiece by making two spaced-apart cutouts to form the connecting web between the two spaced-apart cutouts.

8. The method according to claim 7, which further comprises opening the separating gap into the cutouts on both sides of the squeezed connecting web.

9. The method according to claim 7, which further comprises opening the separating gap into a cutout tip of the cutouts on both sides of the squeezed connecting web.

10. The method according to claim 7, which further comprises producing the cutouts as triangles and forming the connecting web between mutually facing sides of the triangles.

11. The method according to claim 7, which further comprises punching-out or cutting-out the cutouts in the workpiece with a machining beam.

12. The method according to claim 1, which further comprises simultaneously punching the connecting web by using a punching tool and squeezing on one or both sides in the thickness direction of the workpiece at least on the web section adjacent to the workpiece part still to be cut.

13. The method according to claim 1, which further comprises cutting the separating gap with a machining beam or a punching tool.

14. A non-transitory control program product, comprising program code adapted to perform all steps of the method according to claim 1 when the program runs on a control system of a machine tool suitable for performing all the steps of the method.
